(19) United States
(12) Patent Application Publication
(10) Pub. No.: US 2020/0012510 A1
(43) Pub. Date: Jan. 9, 2020

(54) METHODS AND APPARATUSES FOR MULTI-TIERED VIRTUALIZED NETWORK FUNCTION SCALING

(71) Applicant: NOKIA TECHNOLOGIES OY, Espoo (FI)

(72) Inventors: Anatoly ANDRIANOV, Schaumburg, IL (US); Uwe RAUSCHENBACH, Poing (DE); Gergely CSATARI, Budapest (HU)

(21) Appl. No.: 16/494,932

(22) PCT Filed: Mar. 24, 2017
(86) PCT No.: PCT/US2017/024016

§ 371 Date: Sep. 17, 2019

(51) Int. Cl. G06F 9/455; G06F 9/50

(52) U.S. Cl. CPC G06F 9/45558; G06F 2009/4557; G06F 2009/45595; G06F 9/5077

(57) ABSTRACT

Systems, methods, apparatuses, and computer program products for multi-tiered virtualized network function (VNF) scaling are provided. One method includes detecting a need to scale at least one virtualized network function component (VNFC) implemented as a container, monitoring resource utilization by containers and determining remaining capacity within a current virtual machine hosting the containers, and deciding an allocation of the container to a virtual machine based at least on the resource utilization and the remaining capacity. When it is determined that the remaining capacity is low, the method may further include vertical scaling of the current virtual machine by allocating additional virtualized resources to the current virtual machine, and/or horizontal scaling of the current virtual machine by instantiating a new virtual machine and deploying the container to the newly instantiated virtual machine.

### BACKGROUND

### Field

Some embodiments may generally relate to network function virtualization (NFV) and virtualized network function (VNF) management. In particular, certain embodiments may relate to approaches (including methods, apparatuses and computer program products) for multi-tiered VNF scaling.

### Description of the Related Art

Network function virtualization (NFV) refers to a network architecture model that uses the technologies of information technology (IT) virtualization to virtualize entire classes of network node functions into building blocks that may connect, or chain together, to create communication services.

A virtualized network function (VNF) may be designed to consolidate and deliver the networking components necessary to support a full virtualized environment. A VNF may be comprised of one or more virtual machines running different software and processes, on top of standard high-volume servers, switches and storage, or even cloud computing infrastructure, instead of having custom hardware appliances for each network function. One example of a VNF may be a virtual session border controller deployed to protect a network without the typical cost and complexity of obtaining and installing physical units. Other examples include virtualized load balancers, firewalls, intrusion detection devices and WAN accelerators.

In an NFV environment, a VNF may take on the responsibility of handling specific network functions that run on one or more virtualized containers on top of Network Functions Virtualization infrastructure (NFVI) or hardware networking infrastructure, such as routers, switches, etc. Individual virtualized network functions (VNFs) can be combined to form a so called Network Service to offer a full-scale networking communication service.

Virtual network functions (VNFs) came about as service providers attempted to accelerate deployment of new network services in order to advance their revenue and expansion plans. Since hardware-based devices limited their ability to achieve these goals, they looked to IT virtualization technologies and found that virtualized network functions helped accelerate service innovation and provisioning. As a result, several providers came together to create the Network Functions Virtualization industry specification (ETSI ISG NFV group) under the European Telecommunications Standards Institute (ETSI). ETSI ISG NFV has defined the basic requirements and architecture of network functions virtualization.

In NFV, virtualized network functions (VNF) are software implementations of network functions that can be deployed on a network function virtualization infrastructure (NFVI). NFVI is the totality of all hardware and software components that build the environment where VNFs are deployed and can span several locations.

Each VNF may be managed by a VNF manager (VNFM). A VNFM may, for example, determine specific resources needed by a certain VNF when a VNF is instantiated (i.e., built) or altered. The so-called NFV orchestrator (NFVO) is responsible for network service management. A network service is a composition of network functions and defined by its functional and behavioral specification. The NFVO's tasks include lifecycle management (including instantiation, scale-out/in, termination), performance management, and fault management of virtualized network services.

### SUMMARY

One embodiment is directed to a method, which may include detecting a need to scale at least one virtualized network function component (VNFC) implemented as a container, monitoring resource utilization by containers and determining remaining capacity within a current virtual machine hosting the containers, and deciding an allocation of the container to a virtual machine based at least on the resource utilization and the remaining capacity. When it is determined that the remaining capacity is low, the method further comprises vertical scaling of the current virtual machine by allocating additional virtualized resources to the current virtual machine, or horizontal scaling of the current virtual machine by instantiating a new virtual machine and deploying the container to the newly instantiated virtual machine.

Another embodiment is directed to a method, which may include receiving a request from a virtualized network function manager (VNFM) to instantiate the at least one virtualized network function component (VNFC) implemented as a container, and deciding an allocation of the container to a virtual machine based at least on resource utilization and remaining capacity of the virtual machine. When it is determined that the remaining capacity is low, the method further comprises vertical scaling of the current virtual machine by allocating additional virtualized resources to the current virtual machine, or horizontal scaling of the current virtual machine by instantiating a new virtual machine and deploying the container to the newly instantiated virtual machine.

Another embodiment is directed to an apparatus that includes at least one processor, and at least one memory including computer program code. The at least one memory and the computer program code may be configured, with the at least one processor, to cause the apparatus at least to detect a need to scale at least one virtualized network function component (VNFC) implemented as a container, to monitor resource utilization by containers and determine remaining capacity within a current virtual machine hosting the containers, and to decide an allocation of the container to a virtual machine based at least on the resource utilization and the remaining capacity. When it is determined that the remaining capacity is low, the at least one memory and the computer program code may be further configured, with the at least one processor, to cause the apparatus at least to vertical scale the current virtual machine by allocating additional virtualized resources to the current virtual machine, or to horizontal scale the current virtual machine by instantiating a new virtual machine and deploying the container to the newly instantiated virtual machine.

Another embodiment is directed to an apparatus that includes at least one processor, and at least one memory including computer program code. The at least one memory and the computer program code may be configured, with the at least one processor, to cause the apparatus at least to receive a request from a virtualized network function manager (VNFM) to instantiate the at least one virtualized network function component (VNFC) implemented as a container, and to decide an allocation of the container to a virtual machine based at least on resource utilization and remaining capacity of the virtual machine. When it is determined that the remaining capacity is low, the at least one memory and the computer program code may be further configured, with the at least one processor, to cause the apparatus at least to vertical scale the current virtual machine by allocating additional virtualized resources to the current virtual machine, or to horizontal scale the current virtual machine by instantiating a new virtual machine and deploying the container to the newly instantiated virtual machine.

Another embodiment is directed to an apparatus that may include detecting means for detecting a need to scale at least one virtualized network function component (VNFC) implemented as a container, monitoring means for monitoring resource utilization by containers and determining remaining capacity within a current virtual machine hosting the containers, and deciding means for deciding an allocation of the container to a virtual machine based at least on the resource utilization and the remaining capacity. When it is determined that the remaining capacity is low, the apparatus may further include vertical scaling means for vertical scaling of the current virtual machine by allocating additional virtualized resources to the current virtual machine, or horizontal scaling means for horizontal scaling of the current virtual machine by instantiating a new virtual machine and deploying the container to the newly instantiated virtual machine.

Another embodiment is directed to an apparatus that may include receiving means for receiving a request from a virtualized network function manager (VNFM) to instantiate the at least one virtualized network function component (VNFC) implemented as a container, and deciding means for deciding an allocation of the container to a virtual machine based at least on resource utilization and remaining capacity of the virtual machine. When it is determined that the remaining capacity is low, the apparatus may further include vertical scaling means for vertical scaling of the current virtual machine by allocating additional virtualized resources to the current virtual machine, or horizontal scaling means for horizontal scaling of the current virtual machine by instantiating a new virtual machine and deploying the container to the newly instantiated virtual machine.

### BRIEF DESCRIPTION OF THE DRAWINGS

For proper understanding of the invention, reference should be made to the accompanying drawings, wherein:

FIG. 1 illustrates a system depicting an example of a network function virtualization (NFV) management and organization (MANO) architecture framework, according to an embodiment;

FIG. 2 illustrates an example flow diagram of a method, according to an embodiment;

FIG. 3 illustrates a sequence diagram illustrating an example of multi-tiered instantiation flow, according to an embodiment;

FIG. 4 illustrates a sequence diagram illustrating an example of application container scale-out flow, according to an embodiment;

FIG. 5 illustrates an example of multi-tiered instantiation flow with enhanced VNFM, according to an embodiment;

FIG. 6 illustrates an example of application container scale-out flow with enhanced VNFM, according to an embodiment;

FIG. 7 illustrates an example of a multi-tiered instantiation flow with the EM managing application containers, according to an embodiment;

FIG. 8 illustrates an example of application container scale-out flow controlled by the EM, according to an embodiment;

FIG. 9 illustrates an example block diagram of an apparatus according to an embodiment; and

FIG. 10 illustrates a flow diagram of a method, according to an embodiment.

### DETAILED DESCRIPTION

It will be readily understood that the components of the invention, as generally described and illustrated in the figures herein, may be arranged and designed in a wide variety of different configurations. Thus, the following detailed description of embodiments of systems, methods, apparatuses, and computer program products for multi-tiered virtualized network function (VNF) scaling, is not intended to limit the scope of the invention, but is merely representative of some selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

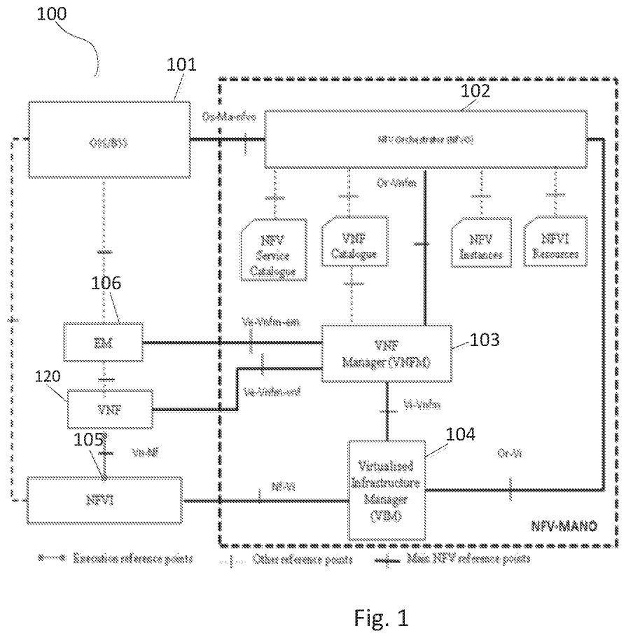

FIG. 1 illustrates a block diagram of a system 100 depicting an example of a network function virtualization (NFV) management and organization (MANO) architecture framework with reference points. The system 100 may include an operations support system (OSS) 101 which comprises one or more entities or systems used by network providers to operate their systems. A Network Manager (NM) is one typical entity/system which may be part of OSS. Further, in the architecture framework system 100 of FIG. 1, OSS/BSS 101 and NFVO 102 may be configured to manage the network service, while element manager (EM) 106 and VNFM 103 may be configured to manage VNF 120.

In a NFV environment, Network Function Virtualization Infrastructure (NEVI) 105 holds the hardware resources needed to run a VNF, while a VNF 120 is designed to provide services. As an example, NFVO 102 may be responsible for on-boarding of new network services (NSs) and VNF packages, NS lifecycle management, global resource management, validation and authorization of NFVI resource requests. VNFM 103 may be responsible for overseeing the lifecycle management of VNF instances. Virtualized infrastructure manager (VIM) 104 may control and manage the NFVI compute, storage, and network resources.

NFVI 105 may be managed by the MANO domain exclusively, while VNF 120 may be managed by both MANO and the traditional management system, such as the element manager (EM) 106. The virtualization aspects of a VNF are managed by MANO (NFVO 102, VNFM 103, and VIM 104), while the application of the VNF 120 is managed by the element manager (EM) 106. A VNF 120 may be configured to provide services and these services can be managed by the element manager (EM) 106.

In NFV, a VNF may be comprised of multiple VNF Components (VNFCs). Each VNFC may generally be implemented on a Virtual Machine (VM) or as a so-called “Container”. Further, a Container may indeed be running in a VM. Thus, a VNF may be comprised of multiple VNFCs that are implemented as one or more Containers, where at least some of the Containers could be hosted on the same VM, which may be referred to as “nested VNFCs.”

Additionally, in NFV, a VNF may be scaled. ETSI NFV GS NFV003 defines scaling as the “ability to dynamically extend/reduce resources granted to the VNF as needed.” The scaling is in turn classified either as scaling out/in which is the “ability to scale by add/remove resource instances (e.g., VM),” or as scaling up/down which refers to the “ability to scale by changing allocated resource, e.g., increase/decrease memory, CPU capacity or storage size.”

In ETSI NFV Release-2 specifications (e.g., IFA008, IFA010, IFA011 and IFA013) developed the approach of scaling further. The scaling may be classified as either “horizontal” or “vertical” (only horizontal VNF scaling is supported by NFV Release-2 specifications); horizontal scaling may either scale out (adding additional VNFC instances to the VNF to increase capacity) or scale in (removing VNFC instances from the INF, in order to release unused capacity); vertical scaling is either scale up (adding further resources to existing VNFC instances, e.g., increase memory, CPU capacity or storage size of the virtualization container hosting a VNFC instance, in order to increase VNF capacity) or scale down (removing resources from existing VNFC instances, e.g. decrease memory, CPU capacity or storage size of the virtualization container hosting a VNFC instance, in order to release unused capacity); the VNFs may be scaled by adding/removing the instances of VNFCs (VNF Components); the VNFC is typically considered containing a single compute resource, where compute resource is a VM (Virtual Machine); and the VNF scaling Lifecycle Management (LCM) operation may be performed by VNFM functional block based either on an internal decision (auto-scaling) or an external request received from according to ETSI NFV GS IFA007, EM or VNF according to ETSI NFV GS IFA008.

Thus, ETSI NFV Release-2 specifications (IFA015) allow VNF to be implemented using various virtualization technologies—for example, VNFC compute resource could be either virtual machine or a container (such as OS container, e.g., Docker). However, the support for VNFs implemented using containers is relatively limited—the LCM operations defined in IFA007 and IFA008 specifications imply that VNFC compute resources are either VMs or containers, but not a combination of these tiered on top of each other. The additional flexibility and issues specific to multi-tier virtualization containers are not properly addressed. It is noted that, in the context of the present disclosure, the term “container” may be used in the specific meaning of container technology (e.g., Docker), whereas the term “virtualization container” is a general term defined by ETSI NFV that includes both virtual machines (VMs) and containers.

In view of the above, although NFV supports the setup of when a Container is running in a VM, there is no mechanism for managing the relationship between these two layers. For example, if a VNF (that is implemented via multiple VNFCs wherein at least some VNFCs are implemented using Containers hosted on one VM) is to be scaled out, according to current ETSI specifications, this would mean that new Containers would be added—but it could happen that the resources of that VM would not suffice for the additional Container(s) needed. More specifically, the following scenario may represent a problem: A VNF is deployed as a set of containers (e.g., OS containers such as Docker containers)—VNF is a VM or a set of containers running on top of VMs; from an application perspective, whenever a need for extra capacity is identified, the containers are scaled out (additional instances of containers are created “on the fly”). The number of container instances that could be created as part of the scale out LCM operation is limited (from consumed resources perspective) by the resources available to the VM where containers are deployed.

Certain embodiments provide an approach for checking and addressing this conflict before the scaling is performed. According to an embodiment, the NFV architecture may be enhanced with the capability to handle nested VNFCs. In one embodiment, for example, the VNF Manager (VNFM) may be enhanced with new capabilities to be able to handle this specific setup.

One embodiment is directed to a hybrid or multi-tiered method for INF scaling which could combine the approaches of horizontal and vertical scaling. In an embodiment, when an application detects a need for additional INF capacity, a method of horizontal scaling may be used to add more instances of VNFC containers. While performing scale-out of containers, a controlling entity (e.g., a VNFM or a new entity) may monitor the resource utilization by the containers and determine (e.g., continuously or periodically determine) the remaining capacity within the VM hosting the containers. If multiple VMs are available for deploying a newly-created container, the controlling entity may make a decision in which of the VMs to deploy the actual container, considering, among other factors, resource utilization in that VM. Such a decision may be influenced by a new class of (anti)affinity rules that indicates placement of a container in a compute instance. Additionally, the decision on where/how to deploy a container may be based on application(s) needs of a particular container type, e.g., whether they will benefit from all being placed into the same “basket” or distributing them across multiple resources, based on cross-container communications needs, redundancy, affinity/anti-affinity requirements, potential for container “breathing,” future resource needs based on trends in application metrics, etc.

In an example embodiment, when a shortage of resources is detected while performing a container scale-out operation, one of two possible actions may be performed by the controlling entity: either scale-up (vertical scale) of VM hosting the containers by allocating additional virtualized resources to this VM (vertical scale) instance, or scale-out (horizontal scale) of VM hosting the containers by instantiating a new VM and deploying or enable the deploying the new containers at this new VM instance.

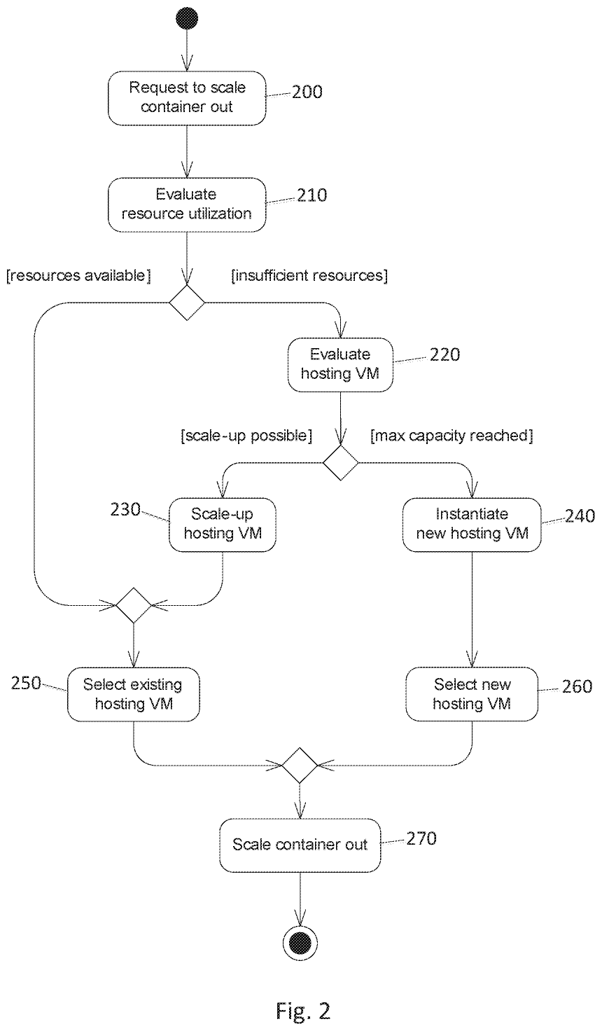

FIG. 2 illustrates an example flow diagram of a method that may be performed by a controlling entity, according to one embodiment. As illustrated in FIG. 2, the method may include, at 200, receiving a request to scale at least one container out. At 210, the controlling entity may determine the resource utilization, for example, of a currently existing hosting VM. If the hosting VM has resources available, then the method may proceed to step 250 where the existing hosting VM is selected and, at 270 the controlling entity may scale the container out.

If, however, the hosting VM has insufficient resources available, then the method may proceed to step 220 where the hosting VM is evaluated. If the evaluation step 220 shows that scale-up of the hosting VM is possible, then the method may include, at 230, scaling-up the hosting VM, selecting the existing hosting VM at 250, and, at 270, the controlling entity may scale the container out.

If the evaluation step 220 shows that maximum capacity of the VM has been reached, then the method may include, at 240, instantiating a new hosting VM, selecting the new hosting VM at 260, and, at 270, the controlling entity may scale the container out.

As outlined above, according to certain embodiments, a new controlling entity responsible for container scaling operations is provided. An example of such a controlling entity could be a new component performing application level monitoring of VNF and container scale-out/scale-in (instantiation/terminations). From a conventional VNFM perspective, only the hosting VMs are visible as VNFCs. VNFC scale-out/scale-in operations that a VNFM is aware of are operations to either instantiate a new hosting VM or terminate a hosting VM that is no longer needed. In the future, where full support for vertical scaling operations may become available, the VNFM may become responsible for hosting VM scale-up/scale-down based on the request of the container management entity.

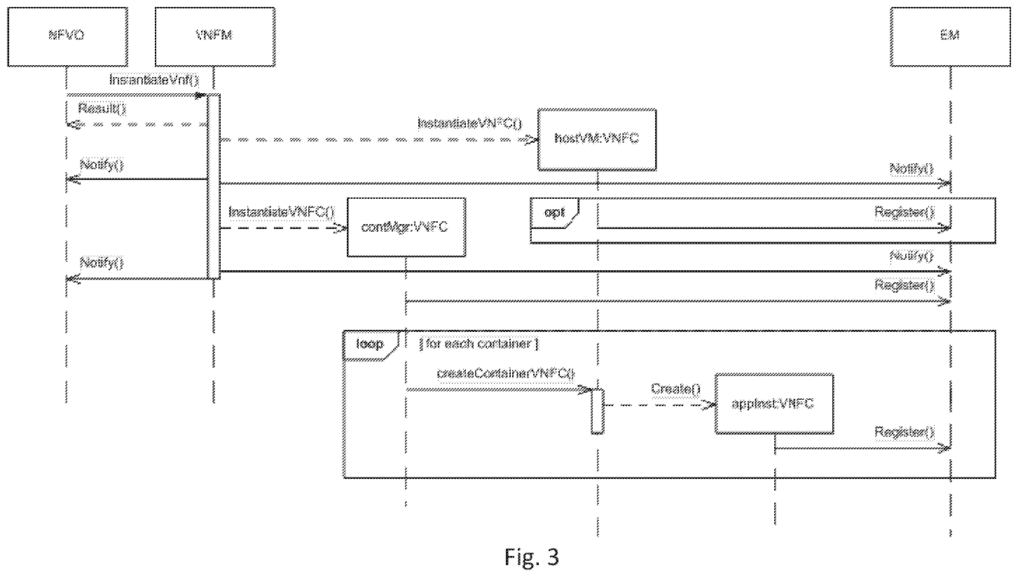

FIG. 3 illustrates a sequence diagram illustrating an example of multi-tiered instantiation flow with a “container manager” entity that may act as the controlling entity, according to an embodiment. In this example sequence of FIG. 3, the instantiation of a new VNF instance is requested by NFVO from the VNFM. The VNFM performs the VNF instantiation by first instantiating the VNFC acting as a “host” for the “container” VNFCs. The VNFM notifies all subscribed entities (NFVO and EM in this example) about individual steps of the VNF instantiation. The newly instantiated “host” VNFC registers itself with the entity managing the application aspects of the VNF (EM in this example flow). Next step performed by the VNFM is instantiation of the “container manager” VNFC. The newly instantiated “container manager” VNFC registers itself with the entity managing the application aspects of the VNF (EM in this example flow). For each “container” VNFC the “container manager” managing entity (“container manager” VNFC in this example) performs individual container creations on the “host” VNFC. Each “container” VNFC registers itself with the entity managing the application aspects of the VNF (EM in this example flow). The application level interaction between application managing entity (EM) is not shown on the flow for simplicity. Alternatively, application managing entity (EM in this example) could interact directly with “container manager” VNFC and request creation or termination of individual containers.

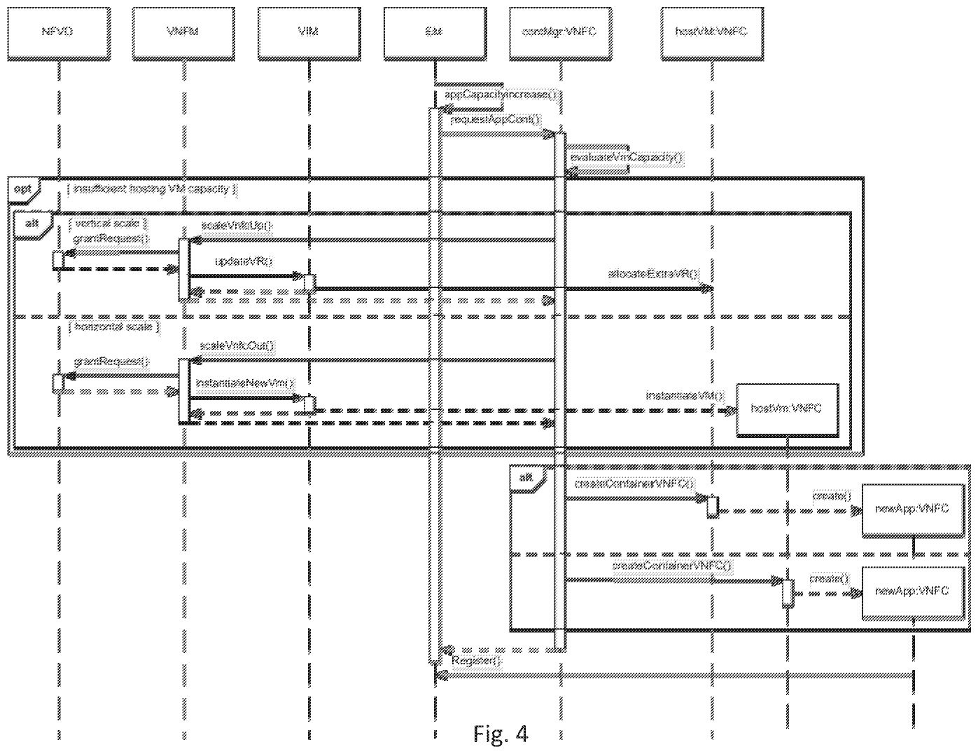

FIG. 4 illustrates an example of application container scale-out flow with a “container manager” entity that may act as the controlling entity, according to an embodiment. In the example of FIG. 4, the application managing entity (e.g. EM) identifies the need for application capacity increase and requests creation of additional containers from the container manager entity (“container manager” VNFC in this example). The container managing entity (“container manager” VNFC in this example) evaluates available “host” (VM) capacity. In case of insufficient host capacity, the container managing entity (“container manager” VNFC in this example) may perform one of the following actions: either request vertical scale of the host (to add more virtual resources to the host VNFC) or request horizontal scale of the host (to add new instances of the host VNFC). These actions are fulfilled via interactions between container manager requesting scale actions, VNFM performing the scale and NFVO granting the scale. The decision whether vertical or horizontal scale of host is to be performed taken by container manager entity (“container manager” VNFC in this example) based on the current and planned container utilization. Once sufficient host resources are available, the container managing entity (“container manager” VNFC in this example) selects the most appropriate host (e.g. to optimize resources utilization or to satisfy redundancy requirements) and creates new container VNFC. Upon creation, the new container VNFCs register themselves with entity managing application aspects.

Another embodiment may be directed to the re-use of VNFM for VNFC container scaling operations. For example, in this embodiment, the NFV architecture may be enhanced with the capability to handle nested VNFCs, where one VNFC (for example a VM) hosts another VNFC (for example on or more containers) and the VNFM is enhanced with new capabilities to be able to handle this setup. The VNFM becomes aware of virtualization containers used for deployment of VNFCs and is responsible for both operations at the container level (instantiation/termination of virtualization containers) and for the operations at the hosting VM level (scale-up/scale-down, instantiation and termination of hosting VMs).

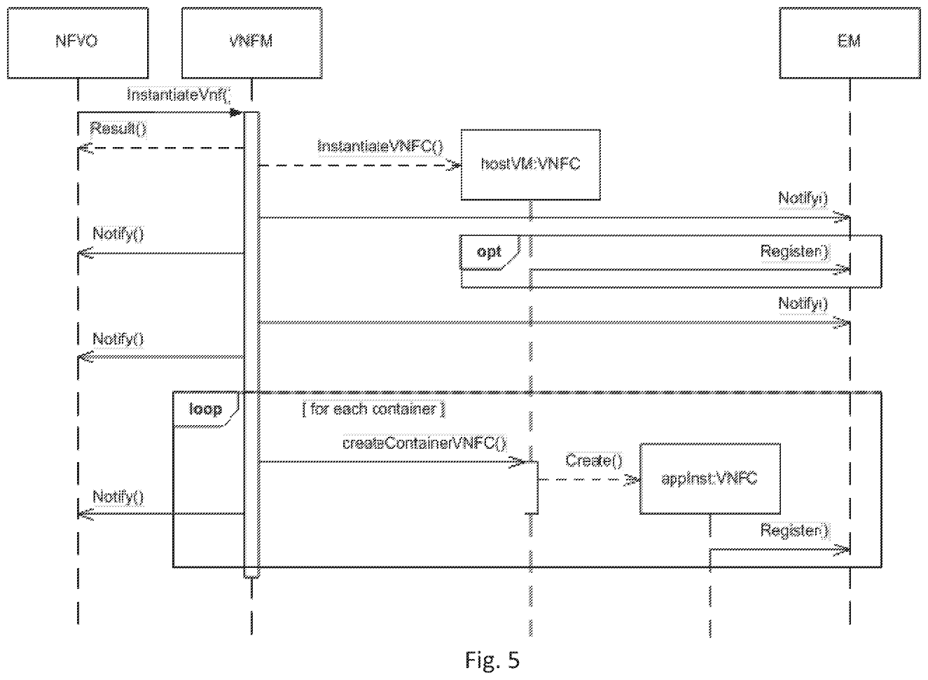

FIG. 5 illustrates an example of multi-tiered instantiation flow with enhanced VNFM, according to an embodiment. In the example sequence of FIG. 5, the instantiation of a new VNF instance is requested by NFVO from the VNFM. The VNFM performs the VNF instantiation by first instantiating the VNFC acting as a “host” for the “container” VNFCs. The VNFM notifies all subscribed entities (NFVO and EM in this example) about individual steps of the VNF instantiation, The newly instantiated “host” VNFC registers itself with the entity managing the application aspects of the VNF (EM in this example flow). Next steps performed by the VNFM as “container manager”. For each “container” VNFC the “container manager” managing entity (VNFM as “container manager” in this example) performs individual container creations on the “host” VNFC. Each “container” VNFC registers itself with the entity managing the application aspects of the VNF (EM in this example flow). The application level interaction between application managing entity (EM) is not shown on the flow for simplicity. Alternatively, application managing entity (EM in this example) could interact directly with VNFM as “container manager” and request creation or termination of individual containers.

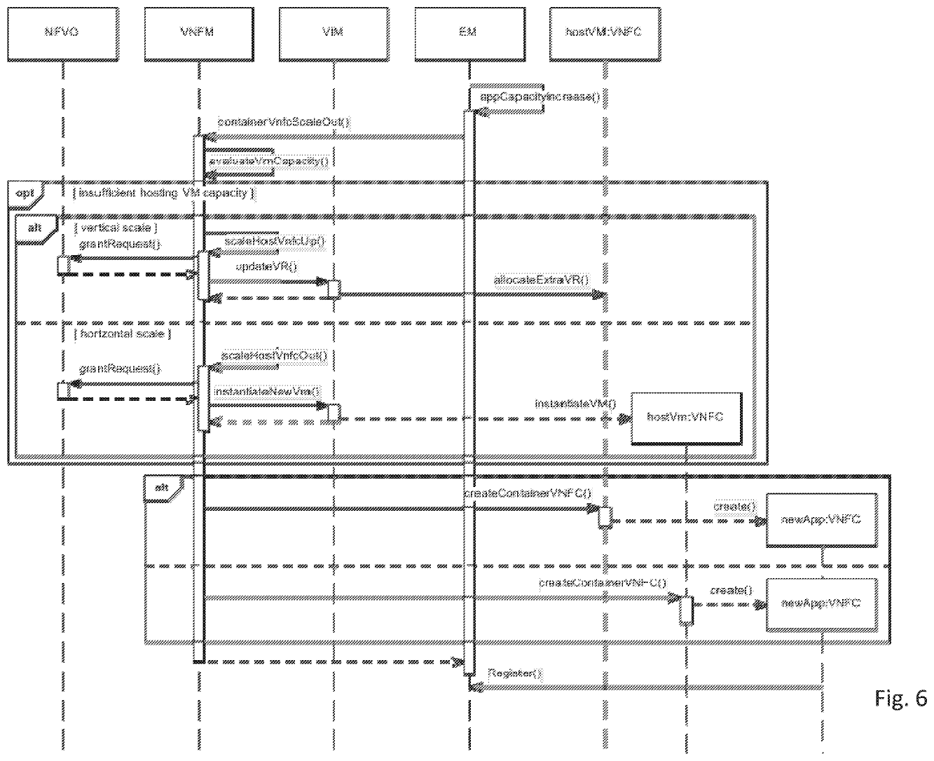

FIG. 6 illustrates an example of application container scale-out flow with enhanced VNFM, according to an embodiment. In the example of FIG. 6, the application managing entity (e.g., EM) identifies the need for application capacity increase and requests creation of additional containers from the container manager entity (enhanced VNFM in this example). The container manager entity (enhanced VNFM in this example) evaluates available “host” (VM) capacity. In case of insufficient host capacity, the container managing entity (enhanced VNFM in this example) may perform one of the following actions: either perform vertical scale of the host (to add more virtual resources to the host VNFC) or perform horizontal scale of the host (to add new instances of the host VNFC). These actions are fulfilled via interactions between VNFM performing the scale and NFVO granting the scale. The decision whether vertical or horizontal scale of host is to be performed taken by container manager entity (enhanced VNFM in this example) based on the current and planned container utilization. Once sufficient host resources are available, the container managing entity (enhanced VNFM in this example) selects the most appropriate host (e.g. to optimize resources utilization or to satisfy redundancy requirements) and creates new container VNFC. Upon creation, the new container VNFCs register themselves with entity managing application aspects.

Another embodiment is directed to the re-use of EM for VNFC container scaling operations. In this embodiment, similar to embodiments outlined above, the existence of VNFCs implemented as virtualization containers may be “hidden” from a (generic) VNFM. However, in this embodiment, no new separate controlling entity is introduced for virtualization container management. Rather, in this embodiment, LCM decision(s) at the virtualization container level may be performed by the EM. When the EM detects a need either for modification of existing hosting VM instance (such as scale-up/down or termination) or for instantiation of a new hosting VM instance, the EM may use the existing VNF LCM interface exposed to EM by VNFM over Ve-Vnfm-em reference point, as depicted in FIG. 1. The EM is a functional block supplied by the VNF provider and, therefore, may have full knowledge about internal VNF architecture (including the details of use of virtualization containers and their LCM operations).

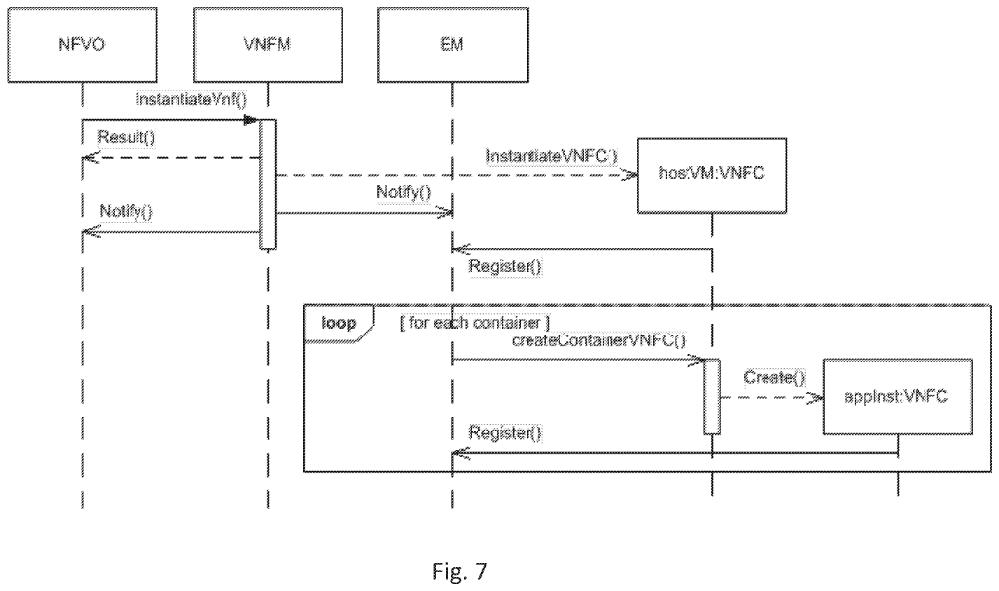

FIG. 7 illustrates an example of a multi-tiered instantiation flow with the EM managing application containers, according to an embodiment. In this example sequence of FIG. 7, the instantiation of a new VNF instance is requested by NFVO from the VNFM. The VNFM performs the VNF instantiation by first instantiating the VNFC acting as a “host” for the “container” VNFCs. The VNFM notifies all subscribed entities (NFVO and EM in this example) about individual steps of the VNF instantiation. The newly instantiated “host” VNFC registers itself with the entity managing the application aspects of the VNF (EM in this example flow). Next steps performed by the EM as “container manager”, For each “container” VNFC the “container manager” managing entity (EM as “container manager” in this example) performs individual container creations on the “host” VNFC. Each “container” VNFC registers itself with the entity managing the application aspects of the VNF (EM in this example flow). The application level interaction between application managing entity (EM) is not shown on the flow for simplicity.

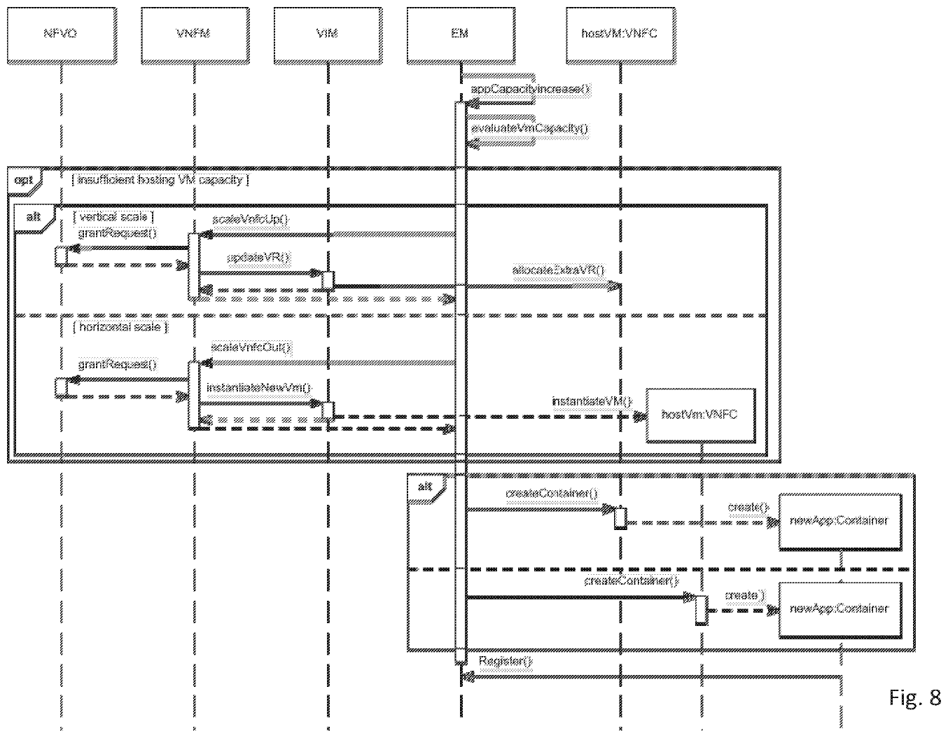

FIG. 8 illustrates an example of application container scale-out flow controlled by the EM, according to an embodiment. In the example of FIG. 8, the EM acting as application and container managing entity identifies the need for application capacity increase and creation of additional containers. The EM evaluates available “host” (VM) capacity. In case of insufficient host capacity, the EM may perform one of the following actions: either request vertical scale of the host (to add more virtual resources to the host VNFC) or request horizontal scale of the host (to add new instances of the host VNFC). These actions are fulfilled via interactions between EM requesting the scale, VNFM performing the scale and NFVO granting the scale. The decision whether vertical or horizontal scale of host is to be performed taken by EM based on the current and planned container utilization. Once sufficient host resources are available, the EM selects the most appropriate host (e.g. to optimize resources utilization or to satisfy redundancy requirements) and creates new container VNFC. Upon creation, the new container VNFCs register themselves with entity managing application aspects.

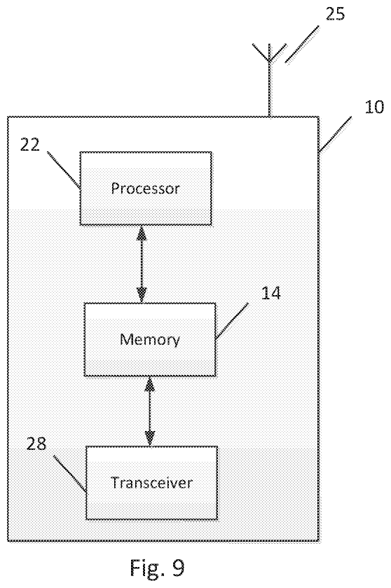

FIG. 9 illustrates an example of an apparatus 10 according to an embodiment. In an embodiment, apparatus 10 may be a node, host, or server in a communications network or serving such a network. In an embodiment, apparatus 10 may be a virtualized apparatus. For example, in certain embodiments, apparatus 10 may be one or more of an element manager, a network manager (e.g., a network manager within an operations support system), a virtualized network function manager, and/or another dedicated entity, or may be any combination of these functional elements. For example, in certain embodiments, apparatus 10 may include a combined element manager and virtualized network function manager in a single node or apparatus. However, in other embodiments, apparatus 10 may be, or be included within, other components within a radio access network or other network infrastructure, such as a base station, access point, evolved node b (eNB), or a 5G or new radio node B (gNB). It should be noted that one of ordinary skill in the art would understand that apparatus 10 may include components or features not shown in FIG. 9.

As illustrated in FIG. 9, apparatus 10 may include a processor 22 for processing information and executing instructions or operations. Processor 22 may be any type of general or specific purpose processor. While a single processor 22 is shown in FIG. 9, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. It should be noted that, in certain embodiments, apparatus 10 may be a virtualized apparatus and processor 22 may be a virtual compute resource.

Apparatus 10 may further include or be coupled to a memory 14 (internal or external), which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein. In other embodiments, memory 14 may be part of virtualized compute resource or virtualized storage resource.

In some embodiments, apparatus 10 may also include or be coupled to one or more antennas 25 for transmitting and receiving signals and/or data to and from apparatus 10. Apparatus 10 may further include or be coupled to a transceiver 28 configured to transmit and receive information. For instance, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly. In some embodiments, transceiver 28 may be comprised of virtualized network resources.

Processor 22 may perform functions associated with the operation of apparatus 10 which may include, for example, precoding of antenna gain/phase parameters, encoding and decoding of individual bits forming a communication message, formatting of information, and overall control of the apparatus 10, including processes related to management of communication resources. As mentioned above, in certain embodiments, processor 22 may be a virtualized compute resource that is capable of performing functions associated with virtualized network resources.

In an embodiment, memory 14 may store software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

In certain embodiments, apparatus 10 may be or may act as an element manager (EM), a network manager (NM), and/or a virtualized network function manager (VNFM), for example. Alternatively, apparatus 10 may be any combination of these functional elements. For example, in certain embodiments, apparatus 10 may be a combined EM and VNFM. According to certain embodiments, a network function may be decomposed into smaller blocks or parts of application, platform, and resources. The network function may be at least one of a physical network function or a virtualized network function.

According to one embodiment, apparatus 10 may be or may act as a controlling entity, a VNFM, and/or an EM. In an embodiment, apparatus 10 may be controlled by memory 14 and processor 22 to perform the functions associated with any embodiments described herein. According to one embodiment, apparatus 10 may be controlled by memory 14 and processor 22 to receive a request, for example from a VNFM or other entity, to instantiate at least one VNFC. In an embodiment, apparatus 10 may be controlled by memory 14 and processor 22 to additionally or alternatively receive a request to, or independently detect a need to, scale at least one VNFC implemented as a container.

According to certain embodiments, apparatus 10 may also be controlled by memory 14 and processor 22 to monitor resource utilization by containers and determine the remaining capacity within a current virtual machine hosting the containers. In an embodiment, apparatus 10 may then be controlled by memory 14 and processor 22 to decide an allocation (e.g., an optimal allocation) of the container to a virtual machine based at least on the resource utilization and the remaining capacity. In some embodiments, apparatus 10 may also be controlled by memory 14 and processor 22 to decide the optimal allocation based on a class of affinity rules that indicate placement of a container in a compute instance. Furthermore, apparatus 10 may decide the optimal allocation based on application(s) needs of a particular container type, e.g., whether they will benefit from all being placed into the same “basket” or distributing them across multiple resources, based on cross-container communications needs, redundancy, affinity/anti-affinity requirements, potential for container “breathing,” future resource needs based on trends in application metrics, etc.

In an embodiment, when it is determined that the remaining capacity is low, apparatus 10 may be controlled by memory 14 and processor 22 to vertical scale the current virtual machine by allocating additional virtualized resources to the current virtual machine, or to horizontal scale the current virtual machine by instantiating a new virtual machine and deploying the container to the newly instantiated virtual machine. For example, in one embodiment, apparatus 10 may be controlled by memory 14 and processor to decide that the optimal allocation is to allocate the container on the current virtual machine. In another embodiment, apparatus 10 may be controlled by memory 14 and processor to decide that the optimal allocation is to allocate the container on a different existing virtual machine. In yet another embodiment, apparatus 10 may be controlled by memory 14 and processor to decide that the optimal allocation is to allocate the container on the newly instantiated virtual machine.

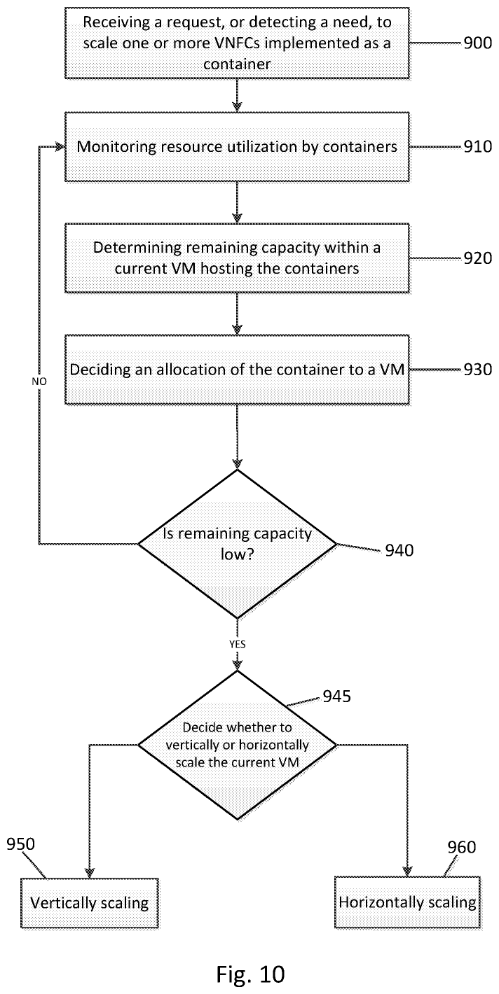

FIG. 10 illustrates an example flow diagram of a method, according to another embodiment of the invention. In certain embodiments the method of FIG. 10 may be performed by a VNFM, EM, or other dedicated entity. In some embodiments, the VNFM, EM, or dedicated entity may include or be comprised in hardware, software, virtualized resources, or any combination thereof.

As illustrated in FIG. 10, the method may include, at 900, receiving a request to, or detecting a need to, scale at least one VNFC implemented as a container. According to certain embodiments, the method may also include, at 910, monitoring resource utilization by containers and, at 920, determining the remaining capacity within a current virtual machine hosting the containers, in an embodiment, the method may also include, at 930, deciding an allocation (e.g., an optimal allocation) of the container to a virtual machine based at least on the resource utilization and the remaining capacity. In some embodiments, the deciding may also include deciding the allocation based on a class of affinity rules that indicate placement of a container in a compute instance. Furthermore, in some embodiments, the deciding of the allocation may include deciding based on application(s) needs of a particular container type, e.g., whether they will benefit from all being placed into the same “basket” or distributing them across multiple resources, based on cross-container communications needs, redundancy, affinity/anti-affinity requirements, potential for container “breathing,” future resource needs based on trends in application metrics, etc.

In an embodiment, the method may also include at 940, determining whether the remaining capacity is low. When it is determined that the remaining capacity is not low, the method may return to step 910 to monitor the resource utilization. When it is determined that the remaining capacity is in fact low, the method may then include, at 945, deciding whether to vertically scale the current virtual machine or to horizontally scale the current virtual machine. If it is decided to vertically scale the virtual machine, then the method may include, at 950, vertically scaling the current virtual machine by allocating additional virtualized resources to the current virtual machine. If it is decided to horizontally scale the virtual machine, then the method may include, at 960, horizontally scaling the current virtual machine by instantiating a new virtual machine and deploying the container to the newly instantiated virtual machine. For example, in one embodiment, the method may include deciding that the allocation is to allocate the container on the current virtual machine. In another embodiment, the method may include deciding that the allocation is to allocate the container on a different existing virtual machine. In yet another embodiment, the method may include deciding that the allocation is to allocate the container on the newly instantiated virtual machine.

In view of the above, embodiments of the invention provide several technical improvements and/or advantages. For example, certain embodiments provide an improved use of virtualization containers, which enables a more flexible control over resources utilization and additional benefits such as accelerated LCM, optimized application deployments, etc. Embodiments may also enable new features and functionality, and may result in improved CPU utilization and speed. As a result, embodiments result in more efficient network services, which may include technical improvements such as reduced overhead and increased speed. As such, embodiments of the invention can improve performance and throughput of network nodes. Accordingly, the use of embodiments of the invention result in improved functioning of communications networks and their nodes, as well as communications devices.

In some embodiments, the functionality of any of the methods, processes, signaling diagrams, or flow charts described herein may be implemented by software and/or computer program code or portions of code stored in memory or other computer readable or tangible media, and executed by a processor.

In certain embodiments, an apparatus may be included or be associated with at least one software application, module, unit or entity configured as arithmetic operation(s), or as a program or portions of it (including an added or updated software routine), executed by at least one operation processor. Programs, also called computer program products or computer programs, including software routines, applets and macros, may be stored in any apparatus-readable data storage medium and include program instructions to perform particular tasks.

A computer program product may comprise one or more computer-executable components which, when the program is run, are configured to carry out embodiments described herein. The one or more computer-executable components may include at least one software code or portions of code. Modifications and configurations required for implementing the functionality of an embodiment may be performed as routine(s), which may be implemented as added or updated software routine(s). In some embodiments, software routine(s) may be downloaded into the apparatus.

Software or a computer program code or portions of code may be in a source code form, object code form, or in some intermediate form, and may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and/or software distribution package, for example. Depending on the processing power needed, the computer program may be executed in a single electronic digital device or it may be distributed amongst a number of devices or computers. The computer readable medium or computer readable storage medium may be a non-transitory medium.

In other embodiments, the functionality may be performed by hardware, for example through the use of an application specific integrated circuit (ASIC), a programmable gate array (PGA), a field programmable gate array (FPGA), or any other combination of hardware and software. In yet another embodiment, the functionality may be implemented as a signal, a non-tangible means that can be carried by an electromagnetic signal downloaded from the Internet or other network.

According to an embodiment, an apparatus, such as a node, device, or a corresponding component, may be configured as a computer or a microprocessor, such as single-chip computer element, or as a chipset, including at least a memory for providing storage capacity used for arithmetic operation(s) and an operation processor for executing the arithmetic operation.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1.-20. (canceled)

21. A method, comprising:
detecting a need to scale at least one virtualized network function component (VNFC) implemented as a container;
monitoring resource utilization by containers and determining remaining capacity within a current virtual machine hosting the containers;
deciding an allocation of the container to a virtual machine based at least on the resource utilization and the remaining capacity; and
when it is determined that the remaining capacity is low, the method further comprises
vertical scaling of the current virtual machine by allocating additional virtualized resources to the current virtual machine, or
horizontal scaling of the current virtual machine by instantiating a new virtual machine and deploying the container to the newly instantiated virtual machine.

22. The method according to claim 21, wherein the deciding further comprises deciding the allocation based on a class of affinity rules that indicate placement of a container in a compute instance.

23. The method according to claim 21, wherein the deciding step results in a decision of allocating the container on the current virtual machine, on a different existing virtual machine or on the newly instantiated virtual machine.

24. A non-transitory computer-readable storage medium having stored thereon computer executable program code which, when executed on a computer system, causes the computer system to perform the steps of claim 21.

25. A method, comprising:
receiving a request from a virtualized network function manager (VNFM) to instantiate the at least one virtualized network function component (VNFC) implemented as a container;
deciding an allocation of the container to a virtual machine based at least on resource utilization and remaining capacity of the virtual machine; and
when it is determined that the remaining capacity is low, the method further comprises
vertical scaling of the current virtual machine by allocating additional virtualized resources to the current virtual machine, or
horizontal scaling of the current virtual machine by instantiating a new virtual machine and deploying the container to the newly instantiated virtual machine.

26. The method according to claim 25, wherein the deciding further comprises deciding the allocation based on a class of affinity rules that indicate placement of a container in a compute instance.

27. The method according to claim 25, wherein the deciding step results in a decision of allocating the container on the current virtual machine, on a different existing virtual machine or on the newly instantiated virtual machine.

28. A non-transitory computer-readable storage medium having stored thereon computer executable program code which, when executed on a computer system, causes the computer system to perform the steps of claim 25.

29. An apparatus, comprising:
at least one processor; and
at least one memory including computer program code,
the at least one memory and the computer program code configured, with the at least one processor, to cause the apparatus at least to
detect a need to scale at least one virtualized network function component (VNFC) implemented as a container;
monitor resource utilization by containers and determine remaining capacity within a current virtual machine hosting the containers;
decide an allocation of the container to a virtual machine based at least on the resource utilization and the remaining capacity; and
when it is determined that the remaining capacity is low, the at least one memory and the computer program code are further configured, with the at least one processor, to cause the apparatus at least to
vertical scale the current virtual machine by allocating additional virtualized resources to the current virtual machine, or
horizontal scale the current virtual machine by instantiating a new virtual machine and deploying the container to the newly instantiated virtual machine.

30. The apparatus according to claim 29, wherein the at least one memory and the computer program code are further configured, with the at least one processor, to cause the apparatus at least to decide the allocation based on a class of affinity rules that indicate placement of a container in a compute instance.

31. The apparatus according to claim 29, wherein the deciding step results in a decision of allocating the container on the current virtual machine, on a different existing virtual machine or on the newly instantiated virtual machine.

32. The apparatus according to claim 29, wherein the apparatus comprises one of a virtualized network function manager, an element manager, or another dedicated entity.

33. An apparatus, comprising:
at least one processor; and
at least one memory including computer program code,
the at least one memory and the computer program code configured, with the at least one processor, to cause the apparatus at least to
receive a request from a virtualized network function manager (VNFM) to instantiate the at least one virtualized network function component (VNFC) implemented as a container;
decide an allocation of the container to a virtual machine based at least on resource utilization and remaining capacity of the virtual machine; and
when it is determined that the remaining capacity is low, the at least one memory and the computer program code are further configured, with the at least one processor, to cause the apparatus at least to
vertical scale the current virtual machine by allocating additional virtualized resources to the current virtual machine, or
horizontal scale the current virtual machine by instantiating a new virtual machine and deploying the container to the newly instantiated virtual machine.

34. The apparatus according to claim 33, wherein the at least one memory and the computer program code are further configured, with the at least one processor, to cause the apparatus at least to decide the allocation based on a class of affinity rules that indicate placement of a container in a compute instance.

35. The apparatus according to claim 33, wherein the deciding step results in a decision of allocating the container on the current virtual machine, on a different existing virtual machine or on the newly instantiated virtual machine.

36. The apparatus according to claim 33, wherein the apparatus comprises one of a virtualized network function manager, an element manager, or another dedicated entity.
